(19) United States
(12) Patent Application Publication
(10) Pub. No.: US 2007/0260702 A1
(43) Pub. Date: Nov. 8, 2007

(54) WEB BROWSER ARCHITECTURE FOR VIRTUAL MACHINE ACCESS

(75) Inventors: David Richardson, Seattle, WA (US); Brian Bershad, Seattle, WA (US); Steven Gribble, Seattle, WA (US); Henry Levy, Seattle, WA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/532,419

(22) Filed: Sep. 15, 2006

Related U.S. Application Data
(60) Provisional application No. 60/746,310, filed on May 3, 2006.

(51) Int. Cl. G06F 15/16

(52) U.S. Cl. 709/217

(57) ABSTRACT

Applications and services are accessed over the Web without requiring any modification to the currently available code for such applications. Virtual machines (VMs) can each be associated with one or more pre-configured and pre-installed software applications and hosted by Web sites. A VM is accessed and run when a user of a client computing device selects a Web object for the VM in a browser program. A plug-in in the browser reads a configuration file for the selected VM from a server and requests a server-side controller daemon to launch the VM on the server. The plug-in then opens a remote desktop connection to the VM, which is displayed as an embedded window in the Web page on the browser program. The user can then interact with and use the VM and its provided application software and services from within the browser program.

### RELATED APPLICATIONS

This application is based on a prior copending provisional application Ser. No. 60/746,310, filed on May 3, 2006, the benefit of the filing date of which is hereby claimed under 35 U.S.C. § 119(e).

### GOVERNMENT RIGHTS

This invention was funded at least in part with a grant (No. CCR-0326546) from the National Science Foundation (NSF), and the U.S. government may have certain rights in this invention.

### BACKGROUND

Recent trends in Web technology have focused on improving a user's experience with a richer set of web services. Broadly referred to as “Web 2.0,” the goal of this second generation of Web services is to provide users with a more dynamic and interactive environment similar to that offered by traditional desktop applications. The rapid growth in popularity of Web 2.0 enabling technologies, like AJAX, CSS, RSS, and SOAP, has to led to a resurgence in new dot-com businesses similar to that experienced in the mid-1990's. Trends seem to indicate that online users are driving this Web transformation as more and more people are using the Web for everything from shopping, to editing documents, to finding dates. Many leading software companies have already embraced Web-based services and applications as the way of delivering software in the future.

However, all of these competing technologies has made it difficult to settle on a set of standards defining what Web 2.0 really means or entails. The result has been an overabundance of new services on the Web to accomplish similar tasks, but with vastly different user interfaces, features, and requirements. For example, a search for AJAX word processors reveals the extent of this new fad. No less than four different online word processors are currently vying for top market share, including AJAXwrite, Zoho Writer, Writely, and Writeboard.

Spending sufficient time with these word processors to become familiar with their capabilities quickly reveals a great lack of the features and stability to which users have grown accustomed when using their more mature desktop counterparts. This realization naturally leads to the question of why the functionality and capability of the existing code base provided in desktop applications cannot be deployed in corresponding Web-enabled applications? Certainly, this dichotomy between Web applications and the corresponding desktop applications might be acceptable in the short term, when relatively small applications are being ported to the Web, but the lack of functionality and capability of Web-enabled applications quickly becomes untenable for large-scale desktop applications like Adobe Photoshop or Microsoft Office, which have not yet been successfully developed as Web-enabled applications with the power of their respective desktop versions. In fact, it seems counterproductive to reinvent a word processor written in AJAX when a robust and time-tested standard word processor such as Microsoft WORD™ is already available for use on the desktop. Clearly, it would be desirable to provide equivalent functionality and capability in Web applications without requiring the investment of time and effort to completely rewrite each such application to run on the Web.

### SUMMARY

On desktop and servers, virtual machines (VMs) have enjoyed growing popularity as a solution for bundling, distributing, configuring, and managing software systems. Because they virtualize entire physical machines, VMs have the power to run any of today's software applications and services with no modifications to the applications. In addition, VMs make software installation trivial because the software is bundled with a properly preconfigured base system on which to run. As such, it has become commonplace for software developers to distribute their applications inside of VMs, and for resource-minded businesses to use VMs to consolidate and reduce the numbers of physical resources, such as servers, that are employed.

Research carried out to address these issues in developing the present novel approach seeks to combine the power and flexibility of VMs with the ubiquitous interaction model of the Web to provide a global solution for integrating computation in various types of software applications, onto the Web. Specifically, a client-server-based architecture has been developed that enables VMs to be treated as Web objects that are integrated into Web pages accessible within a client Web browser program. By transforming VMs into Web objects, clients are enabled to use standard Web browsers to access VMs hosted by Web sites in all of the same ways that images, Flash movies, and other media-type Web objects on the Web are accessed. All of the computing resources such as hard drive space, and processor and memory resources required for each VM and any software running within it are incurred on a hosted server and not on the client computing device. This breakthrough also enables VMs to be widely used by even below-average skill level computer users (who would typically not possess the technical ability to set up a conventional VM), while embedding the full computational power of a desktop computer into Web pages where the software running on a VM can readily be accessed by such users. Moreover, the hosted server provides means by which the access of the VM by a user can be monetized.

This vision has only recently become realistic to implement as a result of recent trends in technology. These trends include the pervasive availability of high-bandwidth networks (e.g., broadband data connections to the home, including DSL, cable, satellite, wireless, and power line), highly efficient remote desktop protocols like VNC and ThinC for decoupling a computer's computation from its display and input, efficient virtualization technology like VMware and Xen, and emerging copy-on-write and fast cloning mechanisms for large-scale replication and management of vast numbers of VMs on a server.

Integrating VMs into the Web browser makes many of today's Web 2.0 technologies irrelevant and insufficient. AJAX-type Web applications make little sense now that it has been shown to be possible to host Web-enabled VMs running their full-featured and familiar desktop application counterparts, as well as other software applications. In general, this new paradigm of VMs as Web objects enables Web developers to instantly make any of today's software available as a Web service without requiring any modifications to be made to the software applications that are thus accessed.

The consequences of this capability are far-reaching. It is now possible to build an array of rich Web services that were impossible or inefficient using previously existing technology. For example, Web-enabled VMs provide a way to easily provide application hosting, software rental, or rent-a-server sites. Users can treat applications just as they would any other Web object, bookmarking their favorite applications and sharing their bookmarks with others, for example, using sites like http://del.icio.us/. Sharing a document, an application, a tutorial, a desktop, or an entire suite of services can be carried out simply by copying and pasting a link into an email. The possibilities are endless. For example, it is now easy to implement a Flickr-like site, RSS feeds, or a Google search for hosted VMs.

Web-enabled VMs also transfer the burden of configuring and maintaining VMs from the client to the content provider, or to a third party. It is important to note that running VMs is still currently not an easily accessible skill for the average computer user. Free technologies like VMware's VMPlayer™ enable users to download VM disk images and run them locally using the provided software. However, users must take the time to download multi-gigabyte files, install, learn about setting up and configuring the VMs (including understanding technical concepts like NAT to enable proper networking), and manage potentially many running VMs over the course of their lifetimes.

With the Web architecture disclosed herein, an entire pre-configured VM is as easy to use as clicking on a hyperlink in a Web page. In fact, just as with other aspects of the Web, users can neither tell, nor do they need to know, where or how the VMs are actually running. Equally as important, this service infrastructure places no specific requirements on content providers. Developing novel VM-integrated Web services becomes as easy and customizable as any other type of Web development is currently.

One aspect of the approach discussed below is thus directed to a method for executing a software application from within a browser program running on a client computing device. The method includes the step of providing a software module (or more generally, appropriate machine executable instructions, which as used herein, is intended to encompass native machine code and non-native machine code, such as JavaScript or interpreted software instructions) for the browser program on the client computing device, to enable the browser program to render a VM as a Web object that is accessible by a user on the client computing device with the browser program. A VM Web object is embedded within a Web page that is accessed on a server computing device, over a network, by the browser program running on the client computing device. The software application is associated with the VM Web object. In response to a user selecting the VM Web object in the browser program, a VM is automatically and transparently executed on the server computing device, so that the software application runs on the VM. The user of the client computing device is thereby enabled to interact with the VM displayed by the browser program.

Another aspect of this technology that is discussed below is directed to a system for causing a software application to execute on a VM running on a server computing device, from within a browser program, so that a user is able to interact with the software application within the browser program. The system includes a memory in which machine instructions are stored. A portion of the machine instructions define the browser program, and another portion of the machine instructions define a module that is adapted to work with the browser program. Also included are a network interface for enabling communications over a network with the server computing device, a display, and a processor coupled to the memory, the network interface, and the display. The processor executes the machine instructions to carry out a plurality of functions. These functions include rendering a Web page on the display when executing the browser program, and employing the module for responding to a user selecting a Web object named as an application, function, or in an otherwise sensible way to the user, and which is included in the Web page. The Web object is associated with the software application, so that the module responds by transmitting a command over the network to the server computing device to execute a VM on the server computing device. The user is thus enabled to access the VM over the network from within the browser program, and thereby interact with the software application in the browser program.

Yet another aspect is directed to a memory medium for storing machine instructions for a module that is adapted to be used with a browser program to enable the browser program to provide user access to a Web object, with the functionality discussed above.

Still another aspect is directed to a server computing system for responding to a selection of a Web object included in a Web page by a user. As noted above, the Web object enables a software application to be executed in a VM and accessed remotely by a client computing device that is displaying the Web page in a browser program. The server computing system includes a memory storing machine instructions. A portion of the machine instructions define a VM, and another portion of the machine instructions define at least one software application that is to be run within the VM. A network interface is provided for enabling communications over a network with the client computing device. A processor is coupled to the memory, the network interface, and the display. The processor executes the machine instructions to carry out a plurality of functions. These functions include responding to a command received from a module running in a browser program on a client computing device, by executing a VM that is running the software application with the processor of the server computing system, and transmitting a graphic image produced by the VM, over the network, to the client computing device, for display within the browser program on the client computing device. The processor in the server computing system responds to commands from the user provided within the browser program and received from the client computing device over the network, to enable the user to interact with the software application.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic diagram of an exemplary prototype architecture for Web-enabled VMs executed on a Web server and accessed by a browser program running on a client computing device;

FIG. 2 is a screenshot showing an exemplary prototype plug-in for Mozilla Firefox™ rendering a cloned version of a VM running Microsoft Corporation's WORD™ word processing program with an exemplary document;

FIG. 3 is an exemplary screenshot showing an application-rich blog developed using the exemplary prototype, wherein miniature, running instances of Microsoft Corporation's WORD™ word processing program and POWER POINT™ presentation program, and Fedora 4 CORE are displayed on the homepage;

FIG. 4 is a schematic block diagram of a generally conventional computing device that is suitable for use either as a client computing device or as a Web server, in carrying out the novel approach disclosed herein;

FIG. 5 is a schematic functional block diagram of an exemplary system for implementing the present novel approach, which enables application programs and other software to be implemented within a VM on a server accessed through a browser program running on a client computing device;

FIG. 6 is a flow chart showing exemplary logical steps for implementing the present novel approach;

FIG. 7 is a flow chart showing exemplary logical steps for enabling a user to access one or more VMs on a server, based upon credentials entered by the user; and

FIG. 8 is a flow chart showing exemplary logical steps for enabling a user to clone a Web VM instance or access a Web VM instance associated with a cookie stored by the client computing device.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive.

### Architecture

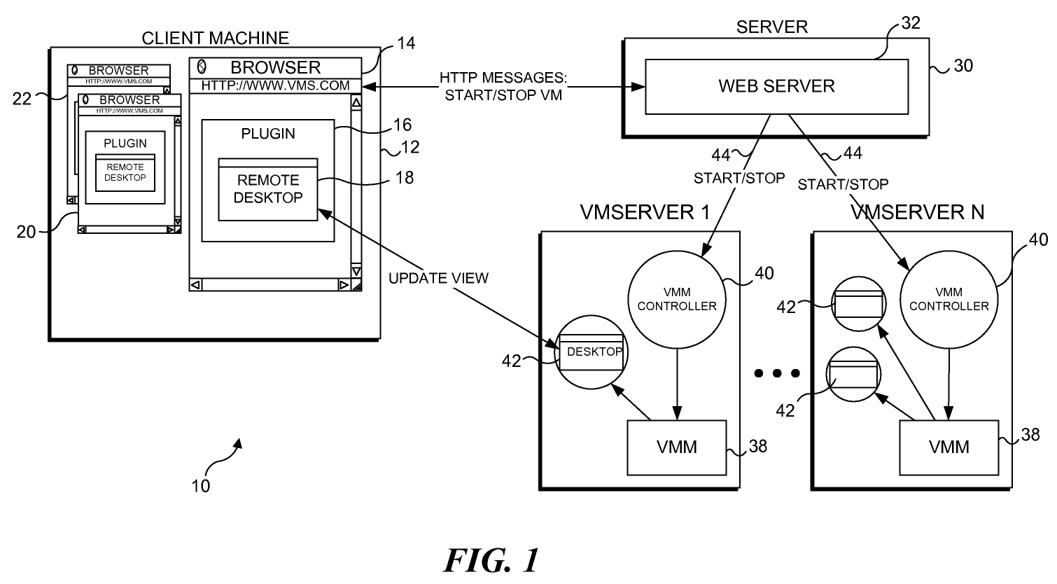

This section describes the architecture for enabling VMs to be treated as Web objects. This architecture is depicted in FIG. 1 and includes two main parts:

A client-side, Web browser plug-in that renders VM Web objects in a client's browser.

A set of server-side services that manage and control Web-hosted VMs.

As with other forms of Web content, the VMs hosted by a Web site are managed and run entirely by the Web site and not by the client. Instead, the job of the browser plug-in is to render an interactive, remote desktop view of the VM in the client's browser program when a corresponding option is selected by the user in the browser program.

To do this, the browser plug-in understands a new MIME Type, which is referred to as “application/vm,” used to represent a VM Web object, much in the same way that a Java plug-in has an associated MIME Type referred to as an “application/x-java-applet,” used for rending Java applets. A VM Web object includes a .vmcfg configuration file that specifies a number of parameters needed by the plug-in to locate, connect to, and authenticate itself to the remote VM. The end result is that the client sees an embedded remote desktop of the VM running within their browser program display.

The browser plug-in, combined with this new MIME Type, define a protocol for embedding VMs into Web pages. With the plug-in installed in a user's browser, VM Web objects look and behave exactly like any other type of Web object, e.g., like an icon in a Web page that can be selected to display an associated image, or play an associated sound file. Thus, the VM Web objects can be added to a Web page in much the same manner that an image, a Flash movie, or a .wav file can be included.

For example, in the past, a software company might have hosted a screenshot of their application “app,” for a new software application product of the company. Instead, using the present technology disclosed herein, the software company can now replace the screenshot with a VM that runs their new software application so that visitors to their Web site can demo the software application easily and without bothering with downloading, installation, or configuration.

Using the architecture disclosed herein, the company's site could create a Web object for this VM by adding an appropriately-defined .vmcfg file, i.e., “app.vmcfg,” for a VM in which their application can be run. An exemplary tag for this new VM Web object is as follows:

<EMBED SRC=“app.vmcfg”
TYPE=“application/vm”
WIDTH=W HEIGHT=H>

Upon visiting the updated page, browsers that include the plug-in can now render a window that displays a W×H pixels (i.e., width-by-height pixels in size) desktop of the VM running the company's new software application. Since the software application only runs within the VM, the company need not be concerned with releasing the underlying machine instructions for the new software application to the public, so that people can demo the product. Full functionality can be provided for the software application running in the VM and the application can be accessed just by the user selecting the associated Web object in the user's browser program display of the company's Web page.

While the protocol defined by the new MIME Type and browser plug-in provides users with a familiar and standard Web-based paradigm for interacting with VMs, all of the details of configuring, managing, and running the VMs are handled by the server's infrastructure. As with other Web service protocols, this architecture does not require that Web servers implement the backend support for hosting VMs in any particular way. For example, the hypertext transport protocol over a secure socket layer (HTTPS) enables the implementation of secure online shopping carts by preventing other parties from determining personal financial information, such as credit card numbers, that are submitted by a user connected to a Web site. However, developers of online shopping carts are free to use the protocol as they see fit to develop their own customized shopping cart software. The protocol's requirements in the present architecture are similar in nature, in that Web developers are free to create VMs that are run and managed by customized software. As long as these VMs are referenced in Web pages as Web objects that adhere to the protocol's MIME-Type specification, browsers that include the plug-in will render the VMs in those Web pages correctly.

This separation between the protocol and the actual implementation employed is key for making VMs “Webified.” One of the reasons that the Web is so powerful is precisely because content providers are free to use protocols like hypertext markup language (HTML), extended markup language (XML), or uniform resource locators (URLs) to innovate their own, customized content. The novel exemplary Web-enabled VM architecture disclosed herein adheres to this vision.

### Exemplary Prototype

To demonstrate the power of this architecture, a prototype server infrastructure 10 that shows off one possible way of hosting VM Web content has been developed. The prototype's architecture is shown in FIG. 1. It is important to note that the exemplary prototype described herein is just one of countless ways of implementing backend support for Web-enabled VMs, in much the same way as BEA Weblogic™, is just one way of implementing Web services. As with other aspects of Web development, it is clearly possible to develop a different customized backend support. For example, a programmer could create simple VM management scripts just as individuals now create their own Web services using MySQL™ or Berkeley DB™. Alternatively, companies could develop their own scalable, high-performance, application-specific infrastructure just as Google or Amazon.com do today.

Regardless of the implementation employed, a Web server 32 running on a server computing device 30 is responsible for hosting a Web site and communicating with a client's browser program 14 that is executed on a client computing device 12, via HTTP, as shown in this exemplary prototype. In this prototype, Web pages hosted on Web server 32 contain links, or other types of HTML or Javascript input forms, which when clicked or selected by a user viewing the Web pages in the display of browser program 14, use HTTP POST to send data via an HTTP request to the Web server to either start or stop a given VM. Web server 32, which is employed in this exemplary prototype, has a computer graphics interface (CGI) script that parses the HTTP POST request to determine the appropriate action to take. The CGI script then sends this control information as a start/stop message 44 to a VM controller 40, which is a daemon running on one of a number (N) of backend VM servers (e.g., VMServer 1 through VMServer N). The daemon running on the VMServer relays this message through a VM monitor (VMM) 38 on the VM server, which takes the appropriate action and either launches or shuts down a VM 42 on the VM server, depending upon the nature of the start/stop message. A current exemplary implementation uses VMware Workstation™ as the VMM. One or more VMs 42 can be executed on each VMServer, and changes in the desktop of the VM as a selected software program is run therein, can be applied to update a remote desktop view 18 of the VM desktop in the display of browser program 14.

Backend servers are selected by the CGI script based on any number of load balancing policies. One current implementation uses a simple, LARD-like approach where VMs are striped across the backend VM servers. For example, VMs with similar installations might be grouped onto the same VM server.

Upon returning from the call to the VMM controller or daemon, CGI script dynamically generates a response HTML Web page to send back to the user's browser program, for display in browser program 14. If the request was to start a VM, then the response sent by the Web server includes an appropriately embedded VM Web object corresponding to the VM that was requested. The HTTP response is sent to client computing device 12, and the browser program on the client computing device renders the resulting Web page. In doing so, a browser plug-in 16 reads the VM Web object's configuration file to establish a remote desktop connection to the running VM on the VM server, and the plug-in displays remote desktop 18 for the running VM in the browser program display. An exemplary implementation of this approach uses the VNC remote desktop protocol. As indicated in FIG. 1, client computing device 12 can simultaneously run and display other browser program windows on its display, for example, browser windows 20 and 22, in which other VMs are being accessed. The other VMs can run the same or different software application programs. These other VMs can be accessed by connecting with the same or entirely different Web servers.

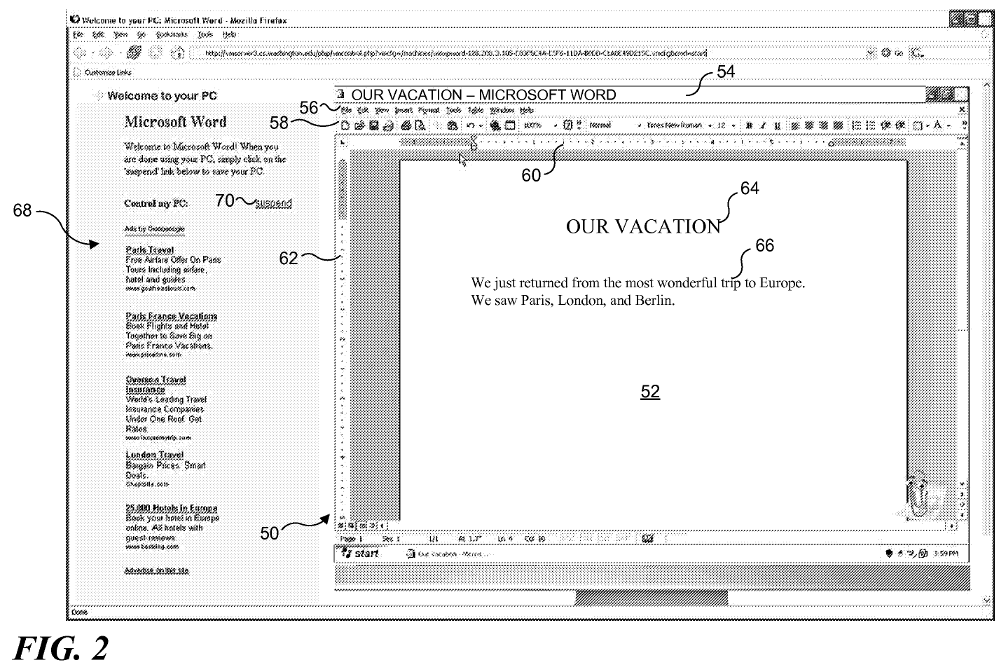

Other operations besides start and stop can also be implemented in this exemplary embodiment. For example, the embodiment currently includes suspend and clone operations. “Suspend HTTP requests” from the user cause the VM in question to suspend instead of shutting down. (An example showing how the user can selectively initiate a suspend request is included in FIG. 2, which is discussed below.) Likewise, a “clone operation” causes the backend VM server to create a new VM that is a copy-on-write clone of an existing VM. An HTTP response that includes a VM Web object for the newly created clone is returned to the user's browser for display in the Web page.

These various types of control operations enable content providers to enforce any number of policies for VM management. For example, a VM with Web controls that only allow for a start operation to be performed might be useful as a machine that can be shared among a number of simultaneous users. Each user that visits the Web site and clicks on the “start” link will get access to the same, shared VM desktop. This scenario is a perfect solution for providing shared, whiteboard-style applications over the Web.

On the other hand, the clone operation enables users of the Web site to produce their own, personal copies of a VM with any one or more application programs that are running therein. The Web page returned to the client as the result of a clone operation can have a unique URL and can embed a unique VM Web object that when selected, causes the browser program (using the plug-in module) to access the desktop of the VM running on the VM server. The exemplary prototype currently implements this functionality. A screenshot in FIG. 2 shows a prototype plug-in for a Mozilla Firefox™ browser program rendering a cloned version 50 of a VM running Microsoft Corporation's WORD™ word processing program, as indicated by the remote desktop display appearing in the browser program. This example illustrates the conventional user interface produced by the WORD software application in which an open document 52 entitled “Our Vacation” is displayed, as will be apparent from a title bar 54 of the WORD program. All conventional features and functionality of the WORD application are provided, including a menu bar 56, a control icon bar 58, a horizontal ruler 60, and a vertical ruler 62, to name but a few. The user can enter text, select control options and carry out all of the functions that are normally available to a user accessing a software application of this type using a remote desktop connection. However, in this novel approach, the user can selectively display and access the VM running on a VM server and the WORD software program can be executed therein by simply selecting the VM Web object on a Web page provided for the site. The user does not need to know anything about the details of installing and setting up a VM, or the operating system and one or more software applications that will run within the VM. Instead, the user simply selects the VM Web object for the VM that is associated with running the WORD software program.

In the exemplary document open in the WORD software program user interface shown in FIG. 2, the user has entered a title 64, and a couple of lines of text relating to the title. One feature that is contemplated in connection with providing a user the ability to run software applications in a remote desktop of a VM accessed through the user's browser window is the potential for advertising revenue. In this example, which is not intended to be in any way considered limiting, text 66 entered by the user has been parsed to determine that it relates to a European vacation or travel. The server running the VM can carry out the parsing of the document text to determine relevant facts about the user's interaction with the VM, and based upon those facts, that are determined, display relevant and coordinated information or advertising. In this example, advertising options 68 are displayed to the left of the open document in the user's Firefox browser display, and the user can select any of these options to request a Web page be opened in the browser window that displays more information and related opportunities for the user to purchase services or products that are relevant to the subject matter entered by the user in the text of the WORD document. It will be apparent that many other types of information and options related to the interaction of the user with the VM can be displayed for selection by the user as desired.

Another source of revenue that can be derived from providing users access to applications running in a VM on a server computing device would be fees that can be charged to the users for such access. There are many revenue models that can be applied to create a fee-based access to such application programs, as will be well known to those of ordinary skill in the art. For example, a user can be charged a predefined fee each time that an application running in a VM on a server computing device is accessed by the user from within the user's browser program. Alternatively, a user can be charged a predefined monthly or annual fee for accessing a specific Web site or VM that gives the user access to applications running within a VM or set of VMs. This fee can be based upon the number of different software applications running on one or more VMs that the user wants to access, or on some other basis that is acceptable to both the user and the party operating the Web site and the server computing device(s) on which the VM(s) are running to enable the software application(s) to be accessed. Control of users accessing software applications running on VMs can be exercised, for example, by employing assigned user names and passwords for each user who has paid or agreed to pay the fee for such access. Also, the fee may be paid by another party to enable the user to access the software application(s) running on a VM. It is also contemplated that the fee can be paid by a company who is advertising on either the Web page or on the VM, as a charge for exposing the user to this advertising of the company. These types of details are not essential to appreciating how revenue can thus be generated.

If the user needs to close the browser window, but has not finished working on a project that was running in a VM accessed through the browser program, the user can, for example, select a “suspend” option 70, which will enable the user to return to work on the project at a later time, effectively maintaining the state of the VM and of the application such as the WORD program that is running in the VM. When the user next selects the Web object for this VM within the display of the user's browser, the same document will be opened in the WORD program running on the VM, so that the user can continue working on it.

Cloning enables clients to bookmark their personal VM's URL, send it to friends, or share it with others, for example, using a web site such as http://del.icio.us/. All of the existing, standard Web authentication procedures and secure connection protocols can be used to enable user accounts on a Web site to maintain each registered user's set of personal VMs. This type of scenario could be easily used as a framework for building a software rental Web site, with VMs and software application specifically tailored to meet the needs of each user of the site.

Of course, these start, stop, suspend, and clone abstractions are by no means necessary. An exemplary backend infrastructure was developed to support these abstractions because it was found convenient and reusable to do so. There is nothing in the present architecture or protocol that precludes a Web developer from building a Web page that just displays a single, shared VM with no user HTML control elements whatsoever, and that approach is certainly contemplated as a very useful alternative.

### Exemplary Applications

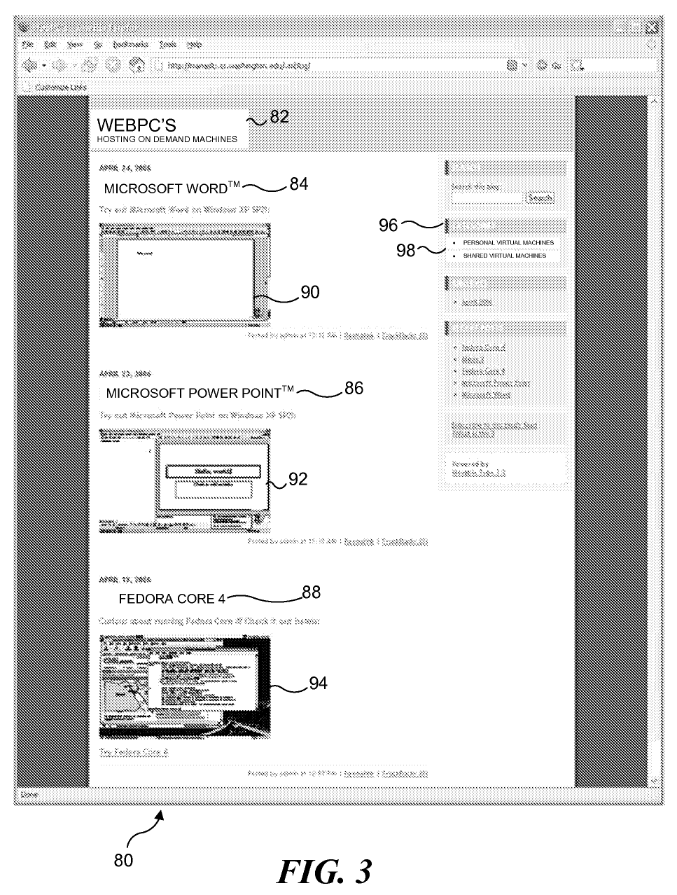

The number of applications and services made possible by this architecture is limited only by the imagination of Web developers. In the list that follows, some ideas that have been developed are provided, but the list is simply exemplary and is not intended to be limiting in any fashion:
A web site for online, on-demand software rental. Users can rent software for a specific period of time. Users' account pages act as a listing of their rented software inventory.
An application portal like Yahoo™, but listing applications instead of Web pages. Along similar lines, a Google™-like search can be made for applications or services.
Rent-a-server Web sites that enable a user to access server-functionality through the browser program of the user.
Rent a cluster of computers at a Web site.
Functionality like that provided by GoToMyPC.comm, but done differently.
Flickr™-like sites for applications instead of photos.
RSS feeds for applications.
Installation-free, configuration-free online demos of software and services; a secure way of implementing “try before you buy,” which does not provide the software to the user, but enables the user to experience the full functionality of the software.
Whiteboard-application sites for online collaboration with any application.
Centralized application servers for enterprises. Corporate IT departments could develop centralized servers for hosting company-specific applications. Applications would be available to employees even if they were out of the office.
ISP-managed and configured application servers for home users. A consumer can pay a company like Comcast™ $X per month to rent and use customized packages of software, much like subscribing to a cable channel package.
Outsource not just data management to Google™ or some other company, but the related computation as well.
Add scalability and substantial computing power to the “$100 laptop” for underprivileged people in developing countries. Schools could deploy a single, centralized computing resource for hosting applications and services needed by students. Students could then use relatively inexpensive, Web-enabled laptops or other computing devices to gain access to these services and the software applications running on them. The hard drive, processor speed, and memory requirements of the software applications do not apply to the computing device that is simply accessing the VMs running software applications.
Interactive student/teacher classroom learning experience. Teachers manage a Web-enabled VM that students can view online and interact with in real-time.
Application-rich blogs: enabling the “right” way of doing VMware's Virtual Appliance site where bloggers host running instances of VMs. An example of such a blog 80 developed using this exemplary prototype is shown in the screenshot of FIG. 3. The Web page blog is identified by a title block 82 as “WEBPC'S, Hosting on Demand Machines.” In this example, the Web page blog includes an option 84 to try Microsoft Corporation's WORD™ program, an option 86 to try Microsoft Corporation's POWER POINT™ program, and an option 88 to try running Fedora Core 4 on a VM. For each of the options, a reduced-size image showing the user interface for the program is provided, as images 90, 92, and 94, respectively. Under a Categories section 96, a user accessing this Web page blog can also select from two categories 98 that list “Personal Virtual Machines,” and “Shared Virtual Machines.”
Application-rich “wikis,” i.e., forums for users to collaborate on and share software, which could be useful for helping geographically dispersed open-source developers.
Geek Squad™ online and on-demand. A user does not need to wait for Geek Squad to come to the user, but can instead, post a computing environment online for interactive customer support.
A user can test a different operating system running on a VM, and execute applications that are specific to that operating system, which can be incompatible with the user's own operating system.

### Exemplary Computing System for Implementing Search

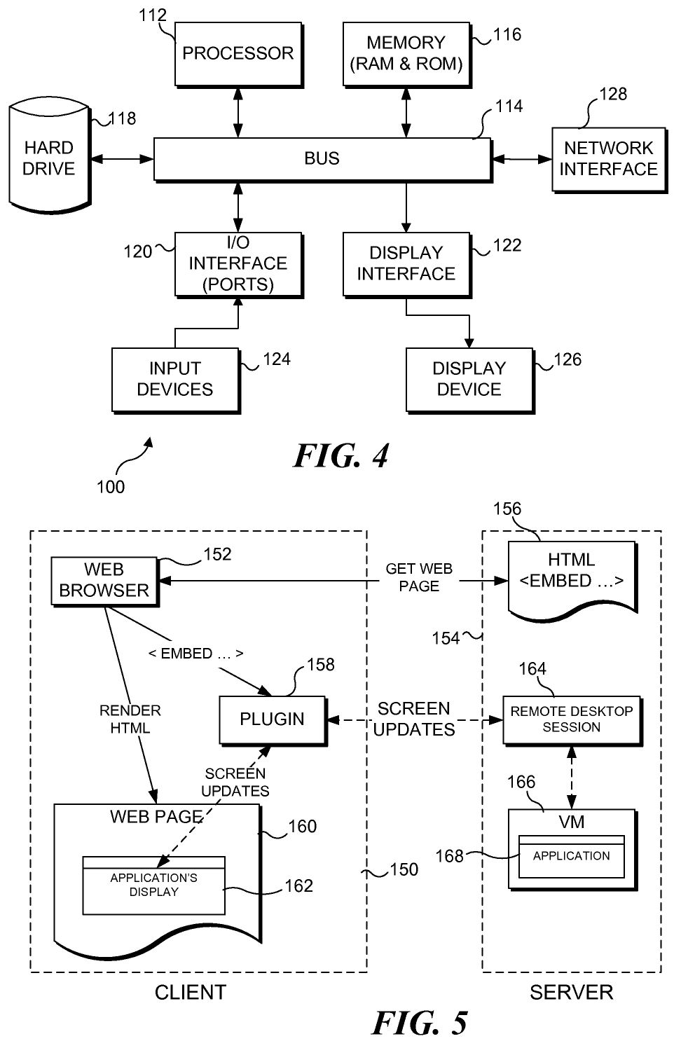

FIG. 4 illustrates an exemplary computing system 100 that is suitable for use either as a computing device employed by a client running a browser program to access a VM or as a server on which one or more VMs is executed, for implementing the novel approach described above. Computing system 100 includes a processor 112 that is coupled in communication with a generally conventional data bus 114. Also coupled to the data bus are a memory 116 that includes both random access memory (RAM) and read only memory (ROM). Machine instructions are loaded into memory 116 from storage on a hard drive 118 or from other suitable non-volatile memory, such as an optical disk or other optical or magnetic media. These machine instructions, when executed by processor 112 can carry out a plurality of different functions employed to implement the approach as described herein, as well as other functions.

An input/output (I/O) interface 120 that includes a plurality of different types of ports, such as serial, parallel, universal serial bus, PS/2, and Firewire ports, is coupled to data bus 114 and is in turn connected to one or more input devices 124, such as a keyboard, mouse, or other pointing device, enabling a user to interact with the computing system and to provide input and control the operation of the computing system. A display interface 122 couples a display device 126 to the data bus, enabling a browser program window and other graphic and text information be displayed for viewing by a user, if computing system 100 comprises a client computing device. The computing system is coupled to a network and/or to the Internet via a network interface 128, which couples to data bus 114.

### Functional Block Diagram

FIG. 5 illustrates further details of the functional relationship between a client computing device 150 running a browser program 152 and a server computing device 154. The server computing device provides access to a hypertext markup language (HTML) Web page 156 with an embedded Web object that can be accessed by the user viewing the Web page in the browser program on client computing device 150. A plug-in module 158 installed in the browser program enables the user's selection of the Web object embedded in Web page 156 to cause an associated VM 166 that may also be associated with one or more software applications 168 installed to run on the VM to be executed on server computing device 154. The plug-in module also enables a remote desktop session 164 corresponding to the desktop in the VM to be provided and updated regularly as a Web page 160 that is displayed within the browser program of the user. That remote desktop session may thus also display a graphic user interface 162 for any software application that is installed and running on the VM to be displayed in the browser program window. As changes in the screen of the desktop/software application occur in the VM, the screen updates are thus visible to the user in the Web page. Also, the user can interact with the desktop and any application software running on it, just as is customary in a remote desktop session.

### Flow Chart Showing Logical Steps

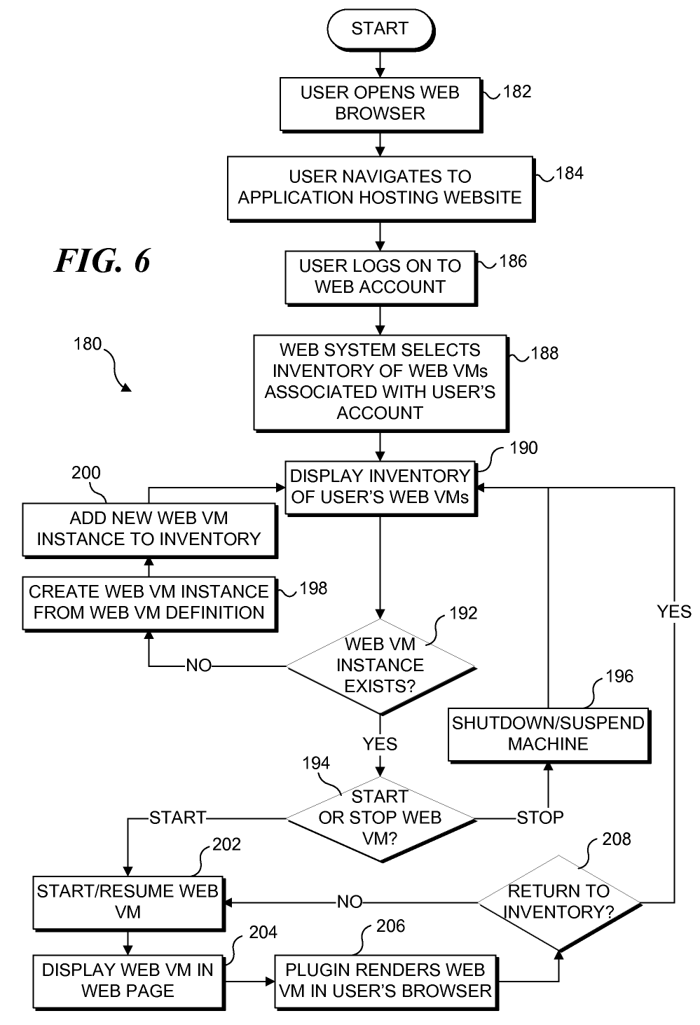

As illustrated in a flow chart 180 in FIG. 6, the process for enabling a user to access a VM executed on a VM server starts with a step 182, wherein the user opens a Web browser program on the client computing device of the user. The user can then, in a step 184, navigate to an application hosting website, or to some other URL where one or more VMs can be accessed. Optionally, the user may have an account with the website, and if so, will likely be required to log on by entry of a user name and password or by providing other required credentials that ensure the user is authorized to log onto the website, as indicated in a step 186. In response to entry of the user's user name and password or submission of other required credentials to the website, the web system controller at the site may access a database to select an inventory of Web VMs that are associated with the user's account, in a step 188. This inventory may include one or more VMs (with any associated software applications) that have previously been accessed by the user. Included within the inventory would be any VM and/or software application running therein that the user had suspended or cloned, or had previously selected as being of interest to the user, even if not previously accessed. In a step 190, the inventory associated with the user's account is displayed to the user within the user's browser program window.

A decision step 192 determines if a specific Web VM instance exists. Typically, the user will have selected a Web object embedded in the inventory of the user's VMs displayed as the specific Web VM instance. A Web VM instance refers to VM (and possibly one or more associated application software programs running in the VM) that has previously been run by the user. If the selected Web VM instance exists, a decision step 194 determines if the user has selectively started or stopped the Web VM instance from within the user's browser program. If the user has stopped the Web VM instance, a step 196 either shuts down the Web VM (and/or associated application software) or suspends the Web VM (and/or associated software), depending upon the actual control choice made by the user. The logic then returns to step 190.

If a Web VM instance selected by the user does not exist in decision step 192, because it is not yet in the user's Web VM inventory, a step 198 creates the Web VM instance from a Web VM definition associated with the Web object selected by the user in the Web VM inventory of the user. A Web VM definition provides appropriate parameters for any associated software application(s) to be run in the VM. For example, the software application may have user specific parameters that can automatically be included in the Web VM definition based upon the identity of the user and information provided by the user when creating an account with the website. A VM definition applies to a prototypical (unbooted) representation of a VM (and any associated software). A step 200 adds the new Web VM instance, which is not booted and running, to the user's Web VM inventory, and the logic continues with step 190.

If a user has started a Web VM in decision step 194, a step 202 either starts or resumes (if suspended) the Web VM selected by the user. A step 204 then displays the Web VM as a Web page in the browser program of the user, a step 206 indicating that the plug-in is employed to render the Web VM in the browser program display. A decision step 208 determines if the user has chosen to return to the display of the user's Web VM inventory, and if not, returns to step 202. If so, the logic again returns to step 190. This logic path can be terminated if the user closes the browser program on the client computing device.

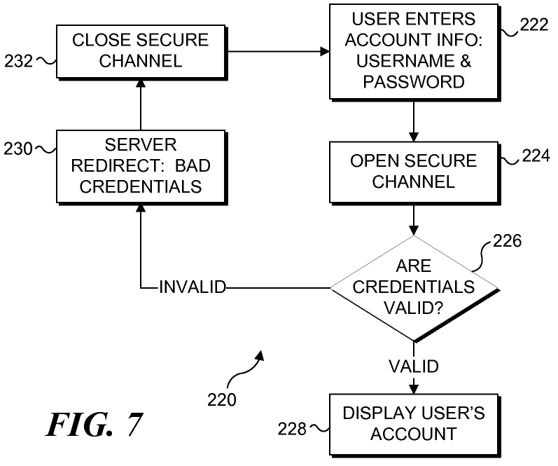

FIG. 7 includes a flow chart 220 that provides more details about the user accessing an account over the Internet (or other network). In a step 222, the user enters account information, which may include at least a username and a password, but can alternatively employ other means for authentication, such as a smartcard and password, or use a biometric scan of fingerprints, retinal pattern, or other such user unique characteristics. In response to the input of this information or data, the server with which the user's browser program is attempting to communicate opens a secure channel over the Internet (or other network), in a step 224. A decision step 226 then determines if the credentials of input data supplied by the user are valid for the requested account. This step can also optionally be employed to check if the user is a subscribed who has paid to access a specific application program running on a VM accessed through the Web page account to which the user is connecting. A subscriber can be required to paid an agreed fee for each access or per a specific time period of access (i.e., metered access), or on a daily, monthly, or annual fee basis. The fee can be based upon each specific one or more application software programs running on one or more VMs, which the user is subscribing to access from within the user's browser program. Alternatively, any required fee can be paid by another party on behalf of the user who is accessing the software program(s) running on one or more VMs. Another approach would be to have the required fee paid by a company that is advertising either on a Web site through which the software program is accessed on a VM, or advertising on the VM where the software application is accessed, based on the user of the software application thus being exposed to the advertising. The fee received for enabling a user to access a software program in a VM from within the user's browser program could also comprise fees generated by two or more of the approaches discussed above.

If the results at decision step 226 are affirmative, a step 228 displays the user's account in a Web page on the user's browser program. Otherwise, if the credentials are invalid, a step 230 redirects the server to a Web page that indicates the credentials are bad or have some other defect. A step 232 then closes the secure channel, returning the user's browser program to step 222, perhaps to retry entry of valid credentials by the user.

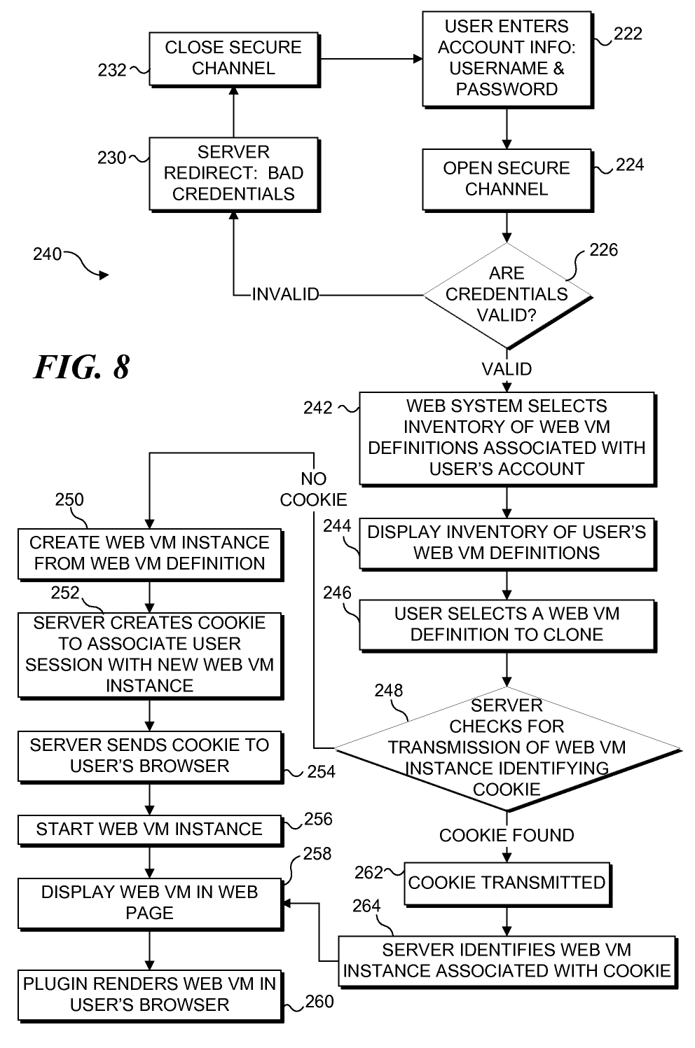

Most of the steps illustrated in FIG. 7 are included in the logical steps of a flowchart 240 shown in FIG. 8. However, if the user's credentials or supplied input is found to be valid in decision step 226, a step 242 in FIG. 8 indicates that the Web system on the server with which the user's browser program is communicating, selects the inventory of Web VM definitions associated with the user's account. In a step 244, the inventory of the user's Web VM definitions are displayed to the user in the browser program, so that in a step 246, the user can select a Web VM definition to clone. A decision step 248 indicates that the server then checks for transmission of a Web VM instance identifying cookie from the browser program of the user running on the client computing device of the user. If a cookie cannot be found, which may occur if the user has not previously opened the Web VM desired or if the cookie has been deleted, a step 250 creates a Web VM instance from the Web VM definition chosen. Next, in a step 252, the server creates a cookie that associates the current user session with the new Web VM instance. The server transmits the cookie to the user's browser in a step 254, so that it can be cached for future use when the same Web VM instance is to be accessed by the user.

A step 256 then starts the new Web VM instance chosen by the user, and the corresponding Web VM desktop (and any associated software application running in it that was part of the user's selection) are displayed in the Web page in the user's browser program display in a step 258. A step 260 employs the plug-in module to render the Web VM in the user's browser program.

If a cookie was found in decision step 248, a step 262 provides for transmitting the cookie to the server from the user's browser program. In a step 264, the server identifies the Web VM instance that is associated with this cookie, and the logic then proceeds with step 258, as noted above.

Emphasis has been placed on the ability of a user to access and use software applications that have been pre-installed and configured on a VM, with the browser program running on the user's client computing device, without requiring any modification to the code for the software applications. However, it should be understood that almost any functionality that can be provided by a VM can be accessed and used in this manner. The concept disclosed herein is thus not limited only to access and use of software applications.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for executing a software application from within a browser program running on a client computing device, comprising the steps of:
(a) providing machine executable instructions for the browser program on the client computing device, to enable the browser program to render a virtual machine (VM) as a Web object that is accessible by a user on the client computing device with the browser program;
(b) embedding a VM Web object within a Web page that is accessed on a server computing device over a network, by the browser program running on the client computing device;
(c) associating the software application with the VM Web object;
(d) in response to a user selecting the VM Web object, executing a VM on a hosted server computing device, so that the software application runs on the VM; and
(e) enabling the user of the client computing device to interact with the VM displayed by the browser program.

2. The method of claim 1, wherein the VM Web object includes a plurality of parameters that enable the machine executable instruction for the browser program to carry out at least one function, the at least one function being selected from the group of functions consisting of:
(a) locating the hosted server computing device on which the VM can selectively be executed;
(b) connecting to the hosted server computing device over the network, to execute the VM;
(c) authenticating the software on the hosted server computing device; and
(d) specifying at least one variable for the software application to use when the software application is run on the VM.

3. The method of claim 2, wherein the step of specifying the at least one variable for the software application to use comprises the step of transmitting a cookie from the client computing device that is associated with a Web VM instance of the VM and the software application that were previously accessed by the client computing device, and which indicates the at least one variable.

4. The method of claim 1, wherein the step of enabling the user to interact with the VM comprises the step of enabling the user to employ the browser program on the client computing device to interact with the software application that is running within the VM on the hosted server computing device.

5. The method of claim 1, further comprising the step of rendering the VM Web object in the browser program on the client computing device, as a remote view of a desktop on the VM executed on the hosted server computing device, wherein the remote view of the desktop includes a display produced by the browser program, corresponding to the software application that is running on the VM.

6. The method of claim 1, wherein the machine executable instructions running in the browser program respond to a configuration file referenced by the VM Web object when the VM Web object is selected by the user.

7. The method of claim 6, wherein the VM Web object comprises a Multimedia Internet Message Extension (MIME) specifying the software application that is associated with the VM Web object.

8. The method of claim 1, wherein the step of enabling the user to interact with the software application comprises the step of enabling the user to issue at least one command, the at least one command comprising at least one of a start command, and a stop command, wherein the start command causes a VM to start executing on the hosted server computing device, and the stop command causes a specific VM to stop executing on the hosted server computing device.

9. The method of claim 1, wherein the step of enabling the user to interact with the VM comprises the step of enabling the user to issue a clone command within the browser program that is transmitted to the hosted server computing device and causes a clone of the VM to be executed on the hosted server computing device with the software application running in the clone of the VM.

10. The method of claim 9, wherein upon receiving the clone command, the hosted server computing device further transmits back to the browser program on the client computing device, a Web page response message that includes a VM Web object for the clone of the VM, to enable the user to have access to the clone of the VM that can be run on the hosted server computing device using the browser program and which is specifically configured for the user.

11. The method of claim 1, wherein the step of enabling the user to interact with the VM comprises the step of enabling the user to issue a suspend command to the VM executing on the hosted server computing device from within the browser program, causing the VM to suspend processing of the software application, without stopping the VM from continuing to execute on the hosted server computing device.

12. The method of claim 1, wherein any of a plurality of different software applications can be selectively executed one at a time, or simultaneously, on the VM, in response to an input by the user in the browser program.

13. The method of claim 1, wherein either the VM, or the software application, or both are selected based upon an identity of the user.

14. The method of claim 1, wherein an identity of the user is indicated by a cookie received by the server computing device from the client computing device.

15. The method of claim 1, wherein either parameters of the VM, or the software application, or both are selected based upon a context of the user determined by the server computing device.

16. The method of claim 15, wherein the context of the user depends upon at least one criterion selected from the group of criteria consisting of:
(a) a localization for the user that corresponds to a location of the user;
(b) a type of client computing device being employed by the user to run the browser program; and
(c) input provided by the user when accessing the Web page.

17. The method of claim 1, further comprising the step of displaying specific content with the application program within the browser program, in response to input by the user in the application program, wherein the server computing machine determines the specific content as being relevant to the input by the user.

18. The method of claim 1, further comprising the step of requiring a fee to be paid to enable the user to access the software application running on the VM with the browser program of the user, wherein the fee is received in accord with at least one of the steps selected from the group consisting of:
(a) receiving payment of the fee from the user;
(b) receiving payment of the fee on behalf of the user; and
(c) receiving a fee based on advertising to which the user is exposed when accessing the software application.

19. A memory medium storing machine readable instructions for a module that is adapted to be used with a browser program to enable the browser program to provide user access to a Web object, so that when the Web object is selected by a user running the browser program on a client computing device, the module enables instructions to be transmitted to a server computing device that cause a virtual machine (VM) to be executed on a hosted server computing device and enable the user on the client computing device to access the VM.

20. The memory medium of claim 19, wherein the module comprises a plug-in for the browser program.

21. The memory medium of claim 19, wherein the module is configured to respond to a configuration file that is associated with the Web object and to run a software application that is indicated in the parameter file, on the VM, when the Web object is selected.

22. The memory medium of claim 21, wherein the parameters enable the module to carry out at least one function selected from the group of functions consisting of:
(a) locating the server computing device on which the VM can selectively be executed;
(b) connecting to the server computing device to execute the VM;
(c) authenticating the module being used on the client computing device, with the server computing device; and
(d) specifying at least one variable for the software application to use when the software application is run on the VM.

23. A system for transparently causing a software application to execute on a virtual machine (VM) running on a server computing device, from within a browser program, so that the user is able to interact with the software application within the browser program, comprising:
(a) a memory storing machine instructions, wherein a portion of the machine instructions define the browser program, and another portion of the machine instructions define a module that is adapted to work with the browser program;
(b) a network interface for enabling communications over a network with the server computing device;
(c) a display; and
(d) a processor coupled to the memory, the network interface, and the display, the processor executing the machine instructions to carry out a plurality of functions, including:
(i) rendering a Web page on the display when executing the browser program;
(ii) employing the module for responding to a user selecting a Web object that is included in the Web page, the Web object being associated with and defining a VM and the software application, the module responding by transmitting a command over the network to the server computing device to execute a VM on the server computing device; and
(iii) enabling the user to access the VM over the network from within the browser program, and thereby interact with the software application in the browser program.

24. The system of claim 23, wherein the machine instructions further cause the processor to respond to configuration parameters that are associated with the Web object, wherein the configuration parameters control how the Web object causes the VM to be executed on the server computing device.

25. The system of claim 23, wherein the configuration parameters enable the module to carry out at least one of the following functions:
(a) identifying and locating the server computing device on which the VM is to be executed, on a network;
(b) connecting to the server computing device to transmit a command that causes the server computing device to execute the VM;
(c) enabling the server computing device to authenticate the module running within the browser program; and
(d) specifying at least one variable for the software application to use when the software application is run on the VM.

26. The system of claim 23, wherein the machine instructions further cause the processor to render a remote view on the display, of a desktop on the VM being executed on the server computing device, wherein the remote view includes information produced by the software application that is running on the VM.

27. The system of claim 23, wherein the machine instructions enable the browser program to respond to a Web object that comprises a Multimedia Internet Message Extension (MIME) specifying the software application that is associated with the Web object.

28. The system of claim 23, wherein the machine instructions cause the processor to enable a user to issue at least one command that is transmitted to the server computing device over the network, the at least one command comprising at least one of a start command, and a stop command, wherein the start command causes a VM to start executing on the server computing device, and the stop command causes a specific VM to stop executing on the server computing device.

29. The system of claim 23, wherein the machine instructions further cause the processor to enable a user to issue a clone command within the browser program, and transmit the clone command to the server computing device over the network, to cause a clone of the VM to be executed on the server computing device, with the software application running in the clone of the VM, so that the clone is also viewed on the display, within the browser program.

30. The system of claim 29, wherein the machine instructions further cause the processor to receive a Web page response message from the server computing device, wherein the Web page response message includes a Web object for the clone of the VM, to enable a user to have access to the clone of the VM that can run on the server computing device and which is specifically configured for the user.

31. The system of claim 23, wherein the machine instructions further cause the processor to enable a user to transmit a suspend command over the network, to the VM executing on the server computing device, the suspend command causing the VM to suspend processing of the software application, without stopping the VM from continuing to execute on the server computing device.

32. The system of claim 23, wherein the machine instructions further cause the processor to enable a user to select any of a plurality of different software applications to be selectively executed one at a time, or simultaneously, on the VM, in response to an input by a user in the browser program.

33. A hosted server computing system for responding to a selection by a user of a Web object included in a Web page, to enable a software application to be executed in a virtual machine (VM) and accessed remotely by a client computing device that is displaying the Web page in a browser program, comprising:
(a) a memory storing machine instructions, wherein a portion of the machine instructions reference a VM that is associated with the Web object, and another portion of the machine instructions define at least one software application also associated with and referenced by the Web object, which is to be run within the VM;
(b) a network interface for enabling communications over a network with the client computing device; and
(c) a processor coupled to the memory, the network interface, and the display, the processor executing the machine instructions to carry out a plurality of functions, including:
(i) responding to a command received from machine executable instructions from within a browser program on a client computing device initiated by a user selecting the Web object, by executing the VM that is running the software application with the processor of the hosted server computing system;
(ii) transmitting a graphic image produced by the VM, over the network, to the client computing device, for display within the browser program on the client computing device; and
(iii) responding to commands from the user provided within the browser program and received from the client computing device over the network, to enable the user to interact with the software application.

34. The system of claim 33, wherein the machine instructions further cause the processor to run an operating system on the VM, and wherein the graphic image produced by the VM that is transmitted over the network corresponds to at least a portion of a desktop for the operating system running on the VM and includes an image produced by the software application that is running under the operating system, on the VM.

35. The system of claim 33, wherein the machine instructions further cause the processor to receive and respond to a command from the module on the client computing device, the command identifying the software application to be run within the VM.

36. The system of claim 35, wherein the machine instructions further cause the processor to receive at least one parameter from the client computing device that is applied to control a predefined function of the at least one software application that is run within the VM.

37. The system of claim 33, wherein the machine instructions further cause the processor to receive and respond to at least one command that is transmitted from the client computing device over the network, the at least one command being selected from the group consisting of a start command, and a stop command, wherein the start command causes the processor to start executing a VM, and the stop command causes the processor to stop executing a specific VM.

38. The system of claim 33, wherein the machine instructions further cause the processor to receive and respond to a clone command, wherein the clone command causes the processor to execute a clone of the VM, with the software application running in the clone of the VM, and then causes the processor to transmit a message to the client computing device with a Web object for accessing the clone of the VM.

39. The system of claim 38, wherein the machine instructions further cause the processor to respond to the user selecting the Web object in the browser program on the client computing device, for accessing the clone of the VM, by executing the clone of the VM with the software application running, to enable the user to access the clone of the VM, which is specifically configured for the user.

40. The system of claim 33, wherein the machine instructions further cause the processor to receive and respond to a suspend command, wherein the suspend command causes the processor to suspend processing of the software application, without stopping execution of the VM.

41. The system of claim 33, wherein the machine instructions further cause the processor to limit access and control of the VM in accord with predefined rights.

42. The system of claim 33, wherein the machine instructions further cause the processor to limit access to the software application running on the VM by users, only to specific users in consideration of a fee having been paid, wherein for each specific user, the fee is paid by at least one party selected from the group consisting of:
(a) the specific user;
(b) another party who has paid the fee on behalf of the specific user; and
(c) an advertiser paying the fee in consideration of the specific user being exposed to advertising while accessing the software application running on the VM.
